(19) United States
(12) Patent Application Publication
(10) Pub. No.: US 2023/0273939 A1
(43) Pub. Date: Aug. 31, 2023

(54) DATA PROCESSING METHOD, APPARATUS AND DEVICE FOR LOCAL STORAGE ENGINE SYSTEM

(71) Applicant: Inspur Electronic Information Industry Co., Ltd., Jinan, Shandong (CN)

(72) Inventor: Youquan XIE, Jinan, Shandong (CN)

(21) Appl. No.: 17/754,800

(22) PCT Filed: May 29, 2020
(86) PCT No.: PCT/CN2020/093088

§ 371 Date: Jan. 10, 2023

(30) Foreign Application Priority Data
Oct. 12, 2019 (CN) 201910968201.3

(51) Int. Cl. G06F 16/27; G06F 16/21

(52) U.S. Cl. CPC G06F 16/278; G06F 16/21

(57) ABSTRACT

A data processing method, apparatus, and device for a local storage engine system, and a computer-readable storage medium. The method includes: dividing a database and building a plurality of sub-databases; building metadata submitting threads corresponding to the sub-databases; when an upper-layer transaction to be processed is received, converting the upper-layer transaction to a local transaction; determining an ID of a target sub-database used by the local transaction; adding the local transaction to a corresponding database queue, giving a notification for a corresponding target metadata submitting thread to extract the local transaction from the database queue, and sequentially processing metadata, needing to be submitted, in the local transaction; and calling a corresponding database interface to submit the metadata. By means of the method, apparatus, and device, and the computer-readable storage medium, parallel processing of metadata is implemented, thereby improving the performance of a local storage engine.

### CROSS REFERENCE TO RELATED APPLICATIONS

This application claims priority to International Application No. PCT/CN2020/093088, filed May 29, 2020, which claims priority to Chinese patent application No. 201910968201.3, entitled “DATA PROCESSING METHOD, APPARATUS, AND DEVICE FOR LOCAL STORAGE ENGINE SYSTEM”, filed with the China National Intellectual Property Administration on Oct. 12, 2019, the disclosure of which is hereby incorporated by reference in its entirety.

### TECHNICAL FIELD

The present application relates to the field of distributed shared storage systems, and in particular, to a data processing method, apparatus, and device for a local storage engine system, and a computer-readable storage medium.

### BACKGROUND

With the rapid development of distributed shared storage systems, the performance and security of the systems are of increasing concern. In mainstream distributed storage systems, the performance of a local storage engine is enhanced by using self-management raw disks. The distributed storage systems are optimized, and most generic features in XFS systems are eliminated to compensate for the lack of support for SSDs.

A local storage engine system based on self-management raw disks is optimized for the use of SSDs to give full play to the performance of SSDs and improve the storage efficiency of a local storage engine. In addition, in the overall architectural design, a logging function is eliminated in a local storage engine system based on a self-management raw disk device, and write amplification is reduced by appending and saving a wal in a database instead to improve the efficiency of writing data to storage. However, the local storage system suffers from serious performance degradation when processing a large number of small blocks of data, and the bottleneck of the system is reflected in the processing capacity of the database. Because data is serially written to storage in the internal structure of the database, the performance of the database is seriously affected when the submission of metadata increases.

In summary, it can be seen that how to improve the performance of the local storage engine while improving the metadata submission efficiency of the local storage engine system is currently a problem to be solved.

### SUMMARY

An objective of the present application is to provide a data processing method, apparatus, and device for a local storage engine system, and a computer-readable storage medium, to resolve the problem in the prior art that the performance of a local storage engine is seriously affected when the submission of metadata increases.

To resolve the foregoing technical problems, the present application provides a data processing method for a local storage engine system, including: executing a database dividing operation on a database of a local storage engine system when the local storage engine system is initialized, so as to obtain N sub-databases, and allocating a number ID and a storage space to each sub-database; building N metadata submitting threads, and allocating a number ID to each metadata submitting thread, so that each metadata submitting thread respectively corresponds to each sub-database on a one-to-one basis; when the local storage engine system receives an upper-layer transaction to be processed, converting the upper-layer transaction to a local transaction; determining, according to a PID of a placement group to which the upper-layer transaction belongs, a target ID of a target sub-database used by the local transaction; adding the local transaction to a database queue corresponding to the target ID, and then sending a local transaction acquisition message to a target metadata submitting thread corresponding to the target ID, so that the target metadata submitting thread places the local transaction into a metadata queue after acquiring the local transaction from the database queue; and acquiring the local transaction from the metadata queue, and submitting metadata, needing to be submitted, of the local transaction to the target sub-database.

Preferably, executing a database dividing operation on a database of a local storage engine system when the local storage engine system is initialized, so as to obtain N sub-databases, and allocating a number ID and a storage space to each sub-database includes:

when the local storage engine system is initialized, dividing the database of the local storage engine system into the N sub-databases according to a configuration parameter, and allocating the number ID and the storage space to each sub-database by using a self-management raw disk device.

Preferably, executing a database dividing operation on a database of a local storage engine system when the local storage engine system is initialized, so as to obtain N sub-databases, and allocating a number ID and a storage space to each sub-database includes:
S1: executing an initialization operation on the local storage engine system, and defining a variable i = 0;
S2: determining whether the variable i is less than a configuration parameter num_db;
S3: if the variable i is less than the configuration parameter num_db, building a sub-database, setting the number ID of the sub-database to i, and allocating a usable storage space to the sub-database; and
S4: after the variable i is updated to i+1, repeating step S2 to step S4 until the variable i is equal to the configuration parameter num_db, to complete initialization of the local storage engine system.

Preferably, the after the local storage engine system receives an upper-layer transaction, converting the upper-layer transaction to be processed to a local transaction includes:

after the local storage engine system receives an upper-layer storage transaction to be processed from a host end, converting the upper-layer storage transaction to a local storage transaction.

Preferably, after the acquiring the local transaction from the metadata queue, and submitting metadata, needing to be submitted, of the local transaction to the target sub-database, the method includes:

calling a callback function to return response information indicating that the metadata has been submitted to the database to an upper layer.

The present application further provides a data processing apparatus for a local storage engine system, including:
a database division module, configured to: execute a database dividing operation on a database of a local storage engine system when the local storage engine system is initialized, so as to obtain N sub-databases, and allocate a number ID and a storage space to each sub-database;
a building module, configured to: build N metadata submitting threads, and allocate a number ID to each metadata submitting thread, so that each metadata submitting thread respectively corresponds to each sub-database on a one-to-one basis;
a conversion module, configured to: when the local storage engine system receives an upper-layer transaction to be processed, convert the upper-layer transaction to a local transaction;
a determination module, configured to determine, according to a PID of a placement group to which the upper-layer transaction belongs, a target ID of a target sub-database used by the local transaction;
a sending module, configured to: add the local transaction to a database queue corresponding to the target ID, and then send a local transaction acquisition message to a target metadata submitting thread corresponding to the target ID, so that the target metadata submitting thread places the local transaction into a metadata queue after acquiring the local transaction from the database queue; and
a submission module, configured to: acquire the local transaction from the metadata queue, and submit metadata, needing to be submitted, of the local transaction to the target sub-database.

Preferably, the database database division module is specifically configured to:

when the local storage engine system is initialized, divide the database of the local storage engine system into the N sub-databases according to a configuration parameter, and allocate the number ID and the storage space to each sub-database by using a self-management raw disk device.

Preferably, the database database division module includes:
an initialization unit, configured to: execute an initialization operation on the local storage engine system, and define a variable i = 0;
a determination unit, configured to determine whether the variable i is less than a configuration parameter num_db;
a building unit, configured to: if the variable i is less than the configuration parameter num_db, build a sub-database, set the number ID of the sub-database to i, and allocate a usable storage space to the sub-database; and
a repetition unit, configured to: after the variable i is updated to i+1, repeat start operations of the determination unit, the building unit, and the repetition unit until the variable i is equal to the configuration parameter num_db, to complete initialization of the local storage engine system.

The present application further provides a data processing device for a local storage engine system, including:

a memory, configured to store a computer program; and a processor, configured to implement, when executing the computer program, the steps of the foregoing data processing method for a local storage engine system.

The present application further provides a computer-readable storage medium, the computer-readable storage medium storing a computer program, the computer program, when executed by a processor, implements the foregoing data processing method for a local storage engine system.

In the data processing method for a local storage engine system provided in the present application, a database of a local storage engine system is first divided when the local storage engine system is initialized, so as to obtain N sub-databases, and a number ID and a storage space are allocated to each sub-database; and N metadata submitting threads are built, and a number ID is allocated to each metadata submitting thread, so that each metadata submitting thread respectively corresponds to each sub-database on a one-to-one basis. During a data write operation, after receiving an upper-layer transaction to be processed, the local storage engine system converts the upper-layer transaction to a local transaction of a local storage engine. A PID of a data placement group to which the upper-layer transaction belongs is then acquired, and a target ID of a target sub-database is calculated according to the PID and is used for saving metadata of a data object. The local transaction is added to a queue corresponding to the target ID, a notification is given to a target metadata submitting thread corresponding to the target ID to extract the local transaction from the corresponding database queue, metadata, needing to be submitted, in the local transaction is processed once, and a corresponding database interface is called to submit the metadata. By means of the method provided in the present application, a database is divided to build a plurality of databases, all objects are grouped, and metadata of a designated object is saved in a corresponding database, so that parallel processing of metadata is implemented, thereby improving the performance of a local storage engine while improving metadata submission efficiency.

### BRIEF DESCRIPTION OF THE DRAWINGS

For clearer descriptions of the technical solutions in the embodiments of the present application or the prior art, the following briefly introduces the accompanying drawings required for describing the embodiments or the prior art. Apparently, the accompanying drawings in the following description show merely some embodiments of the present application, and persons of ordinary skill in the art may still derive other drawings from these accompanying drawings without creative efforts.

FIG. 1 is a flowchart of a first specific embodiment of a data processing method for a local storage engine system according to the present application;

FIG. 2 is a flowchart of a second specific embodiment of a data processing method for a local storage engine system according to the present application; and

FIG. 3 is a structural block diagram of a data processing apparatus for a local storage engine system according to an embodiment of the present application.

### DETAILED DESCRIPTION

The core of the present application is to provide a data processing method, apparatus, and device for a local storage engine system, and a computer-readable storage medium, to implement parallel processing of metadata, thereby improving the performance of a local storage engine.

To enable a person skilled in the art to better understand the solutions of the present application, the present application is further described below in detail with reference to the accompanying drawings and specific implementations. Apparently, the described embodiments are merely some rather than all of the embodiments of the present application. All other embodiments obtained by persons of ordinary skill in the art based on the embodiments of the present application without creative efforts shall fall within the protection scope of the present application.

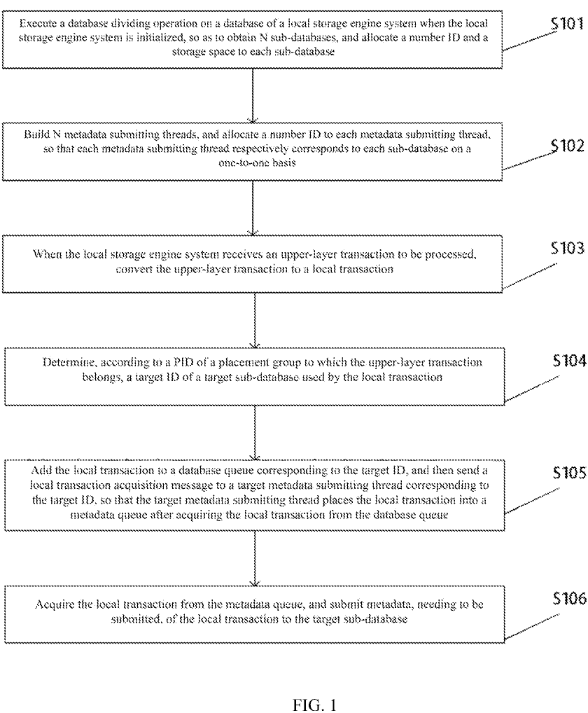

FIG. 1 is a flowchart of a first specific embodiment of a data processing method for a local storage engine system according to the present application. Specific operation steps are as follows:

Step S101: Execute a database dividing operation on a database of a local storage engine system when the local storage engine system is initialized, so as to obtain N sub-databases, and allocate a number ID and a storage space to each sub-database.

Step S102: Build N metadata submitting threads, and allocate a number ID to each metadata submitting thread, so that each metadata submitting thread respectively corresponds to each sub-database on a one-to-one basis.

Step S103: When the local storage engine system receives an upper-layer transaction to be processed, convert the upper-layer transaction to a local transaction.

Step S104: Determine, according to a PID of a placement group to which the upper-layer transaction belongs, a target ID of a target sub-database used by the local transaction.

In this embodiment, the PID is a process control identifier, and is the abbreviation of “process identifier”. The PID is an identifier of each process. The system automatically allocates a unique PID to a process as soon as a program starts to run. The PID is recycled by the system after the process is stopped, and may continue to be allocated to a newly run program. The PID represents a process ID of each process. That is, the PID is an identifier of each process.

Step S105: Add the local transaction to a database queue corresponding to the target ID, and then send a local transaction acquisition message to a target metadata submitting thread corresponding to the target ID, so that the target metadata submitting thread places the local transaction into a metadata queue after acquiring the local transaction from the database queue.

Step S106: Acquire the local transaction from the metadata queue, and submit metadata, needing to be submitted, of the local transaction to the target sub-database.

In the method provided in this embodiment, a plurality of databases are added, all objects are grouped, and metadata of a designated object is saved in a corresponding database, so that metadata of objects can be processed in parallel in the databases, thereby improving the performance of a local storage engine.

Based on the foregoing embodiment, in this embodiment, a quantity of sub-databases to be built is determined according to a configuration parameter. After the submission of metadata is completed, a callback function is called to return response information indicating that the metadata has been submitted to the database to an upper layer.

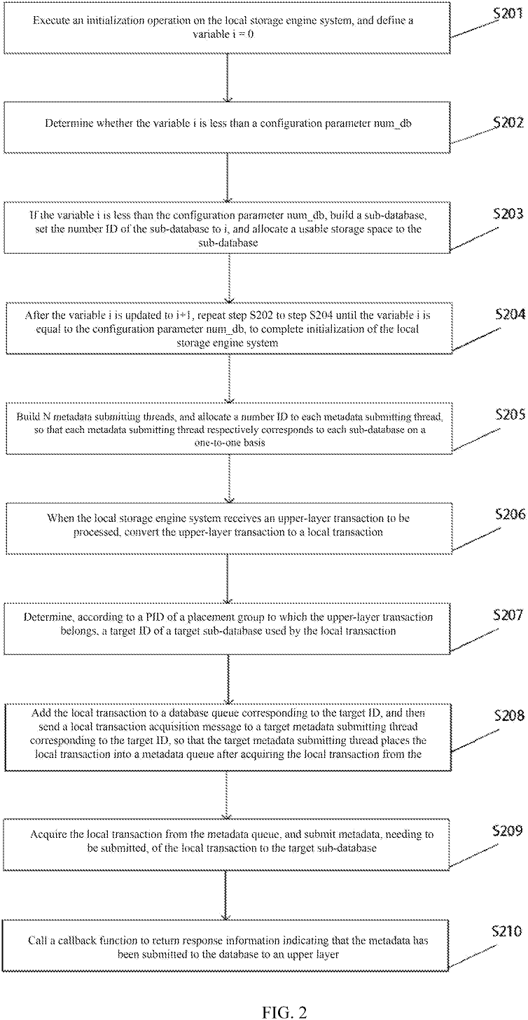

FIG. 2 is a flowchart of a second specific embodiment of a data processing method for a local storage engine system according to the present application. Specific operation steps are as follows:

Step S201: Execute an initialization operation on the local storage engine system, and define a variable i = 0.

Step S202: Determine whether the variable i is less than a configuration parameter num_db.

Step S203: If the variable i is less than the configuration parameter num_db, build a sub-database, set the number ID of the sub-database to i, and allocate a usable storage space to the sub-database.

Step S204: After the variable i is updated to i+1, repeat step S202 to step S204 until the variable i is equal to the configuration parameter num_db, to complete initialization of the local storage engine system.

Step S205: Build N metadata submitting threads, and allocate a number ID to each metadata submitting thread, so that each metadata submitting thread respectively corresponds to each sub-database on a one-to-one basis.

Step S206: When the local storage engine system receives an upper-layer transaction to be processed, convert the upper-layer transaction to a local transaction.

After the local storage engine system receives an upper-layer storage transaction t to be processed from a host end, converting the upper-layer storage transaction t to a local storage transaction txc.

Step S207: Determine, according to a PID of a placement group to which the upper-layer transaction belongs, a target ID of a target sub-database used by the local transaction.

The PID of the placement group to which the upper-layer transaction belongs is acquired, and the id of the target sub-database used by the local transaction txc is calculated according to the PID.

Step S208: Add the local transaction to a database queue corresponding to the target ID, and then send a local transaction acquisition message to a target metadata submitting thread corresponding to the target ID, so that the target metadata submitting thread places the local transaction into a metadata queue after acquiring the local transaction from the database queue.

The local transaction txc is added to a corresponding to database queue queue[txc->id]. The local transaction in a corresponding queue queue[id] is acquired according to an id of a thread, and is placed in a queue kv_queue.

Step S209: Acquire the local transaction from the metadata queue, and submit metadata, needing to be submitted, of the local transaction to the target sub-database.

Metadata in all local transactions in kv_queue is sequentially submitted to the target sub-database.

Step S210: Call a callback function to return response information indicating that the metadata has been submitted to the database to an upper layer.

In this embodiment, based on a division method for optimizing a local storage database, a quantity of databases is increased to improve the concurrence of databases, to improve the storage performance and efficiency of databases, thereby improving the overall performance of the system. In addition, in this embodiment, the quantity of databases is increased to enhance the data processing capability of a local storage engine, so that upper-layer load is mitigated, and the load is split, thereby reducing the overall time consumption of the local storage engine.

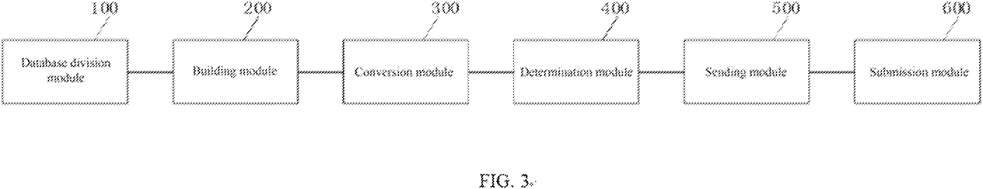

FIG. 3 is a structural block diagram of a data processing apparatus for a local storage engine system according to an embodiment of the present application. The specific apparatus may include:
a database division module 100, configured to: execute a database dividing operation on a database of a local storage engine system when the local storage engine system is initialized, so as to obtain N sub-databases, and allocate a number ID and a storage space to each sub-database;
a building module 200, configured to: build N metadata submitting threads, and allocate a number ID to each metadata submitting thread, so that each metadata submitting thread respectively corresponds to each sub-database on a one-to-one basis;
a conversion module 300, configured to: when the local storage engine system receives an upper-layer transaction to be processed, convert the upper-layer transaction to a local transaction;
a determination module 400, configured to determine, according to a PID of a placement group to which the upper-layer transaction belongs, a target ID of a target sub-database used by the local transaction;
a sending module 500, configured to: add the local transaction to a database queue corresponding to the target ID, and then send a local transaction acquisition message to a target metadata submitting thread corresponding to the target ID, so that the target metadata submitting thread places the local transaction into a metadata queue after acquiring the local transaction from the database queue; and
a submission module 600, configured to: acquire the local transaction from the metadata queue, and submit metadata, needing to be submitted, of the local transaction to the target sub-database.

The data processing apparatus for a local storage engine system in this embodiment is configured to implement the foregoing data processing method for a local storage engine system. Therefore, for a specific implementation of the data processing apparatus for a local storage engine system, reference may be made to the embodiment part of the foregoing data processing method for a local storage engine system. For example, the database division module 100, the building module 200, the conversion module 300, the determination module 400, the sending module 500, and the submission module 600 are respectively configured to implement steps S101, S102, S103, S104, S105, and S106 in the foregoing data processing method for a local storage engine system. Therefore, for specific implementations of the modules, reference may be made to the description of corresponding embodiment parts. Details are not described again herein.

Specific embodiments of the present application further provide a data processing device for a local storage engine system, including: a memory, configured to store a computer program; and a processor, configured to implement, when executing the computer program, the steps of the foregoing data processing method for a local storage engine system.

Specific embodiments of the present application further provide a computer-readable storage medium, the computer-readable storage medium storing a computer program, the computer program, when executed by a processor, implements the foregoing data processing method for a local storage engine system.

All embodiments are described in the present application in a progressive manner. Each embodiment describes only the difference from other embodiments. For the same or similar parts among all embodiments, reference may be made to the relevant parts. For the apparatus disclosed in the embodiments, because the apparatus corresponds to the method disclosed in the embodiments, the description is relatively simple. For related parts, reference may be made to the description of the method part.

A person skilled in the art may further be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

Steps of methods or algorithms described in the embodiments disclosed in this specification may be directly implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The data processing method, apparatus, and device for a local storage engine system, and the computer-readable storage medium provided in the present application are described above in detail. Although the principle and implementations of the present application are described by using specific examples in this specification, descriptions of the embodiments are merely intended to help understand the methods and core idea of the present application. It should be noted that for a person of ordinary skill in the art, several improvements and modifications may further be made to the present application without departing from the principle of the present application. These improvements and modifications should also fall within the protection scope of the claims of the present application.

1. A data processing method for a local storage engine system, comprising:
executing a database dividing operation on a database of a local storage engine system when the local storage engine system is initialized, so as to obtain N sub-databases, and allocating a number ID and a storage space to each sub-database;
building N metadata submitting threads, and allocating a number ID to each metadata submitting thread, so that each metadata submitting thread respectively corresponds to each sub-database on a one-to-one basis;
when the local storage engine system receives an upper-layer transaction to be processed, converting the upper-layer transaction to a local transaction;
determining, according to a PID of a placement group to which the upper-layer transaction belongs, a target ID of a target sub-database used by the local transaction;
adding the local transaction to a database queue corresponding to the target ID, and then sending a local transaction acquisition message to a target metadata submitting thread corresponding to the target ID, so that the target metadata submitting thread places the local transaction into a metadata queue after acquiring the local transaction from the database queue; and
acquiring the local transaction from the metadata queue, and submitting metadata, needing to be submitted, of the local transaction to the target sub-database.

2. The method according to claim 1, wherein executing a database dividing operation on a database of a local storage engine system when the local storage engine system is initialized, so as to obtain N sub-databases, and allocating a number ID and a storage space to each sub-database comprises:
when the local storage engine system is initialized, dividing the database of the local storage engine system into the N sub-databases according to a configuration parameter, and allocating the number ID and the storage space to each sub-database by using a self-management raw disk device.

3. The method according to claim 2, wherein executing a database dividing operation on a database of a local storage engine system when the local storage engine system is initialized, so as to obtain N sub-databases, and allocating a number ID and a storage space to each sub-database comprises:
S1: executing an initialization operation on the local storage engine system, and defining a variable i = 0;
S2: determining whether the variable i is less than a configuration parameter num_db;
S3: if the variable i is less than the configuration parameter num_db, building a sub-database, setting the number ID of the sub-database to i, and allocating a usable storage space to the sub-database; and
S4: after the variable i is updated to i+1, repeating step S2 to step S4 until the variable i is equal to the configuration parameter num_db, to complete initialization of the local storage engine system.

4. The method according to claim 1, wherein when the local storage engine system receives an upper-layer transaction to be processed, converting the upper-layer transaction to a local transaction comprises:
after the local storage engine system receives an upper-layer storage transaction to be processed from a host end, converting the upper-layer storage transaction to a local storage transaction.

5. The method according to claim 1, wherein after the acquiring the local transaction from the metadata queue, and submitting metadata, needing to be submitted, of the local transaction to the target sub-database, the method comprises:
calling a callback function to return response information indicating that the metadata has been submitted to the database to an upper layer.

6-8. (canceled)

9. A data processing device for a local storage engine system, comprising:
a memory, configured to store a computer program; and
a processor, configured to implement, when executing the computer program, the steps of the data processing method for a local storage engine system according to claim 1.

10. A computer-readable storage medium, the computer-readable storage medium storing a computer program, the computer program, when executed by a processor, implements the data processing method for a local storage engine system according to claim 1.
